(19) United States
(12) Patent Application Publication
(10) Pub. No.: US 2025/0200133 A1
(43) Pub. Date: Jun. 19, 2025

(54) PARALLEL INTEGRATED COLLECTIVE COMMUNICATION AND MATRIX MULTIPLICATION OPERATIONS

(71) Applicant: ADVANCED MICRO DEVICES, INC., Santa Clara, CA (US)

(72) Inventors: Kishore Punniyamurthy, Austin, TX (US); Khaled Hamidouche, Austin, TX (US); Brandon K. Potter, Troup, TX (US); Ruchi Shah, Austin, TX (US)

(21) Appl. No.: 18/538,498

(22) Filed: Dec. 13, 2023

(51) Int. Cl. G06F 17/16

(52) U.S. Cl. CPC G06F 17/16

(57) ABSTRACT

Techniques are described for efficiently performing integrated matrix multiplication operations to compute an output matrix based on two input matrices. Data corresponding to a first input tile of a first input matrix is retrieved and stored in a local buffer. For each output tile of the output matrix, a non-blocking remote call is initiated to retrieve data corresponding to a next tile of the first input matrix into the local buffer and, concurrently with the processing of this remote call, iteratively computes the output tile using the data of the first input matrix stored in the local buffer and a unidimensional sequence of input tiles from the second input matrix. The output matrix is generated based on the iteratively computed output tiles.

### BACKGROUND

Techniques described herein generally relate to parallel computing, and more specifically to the field of large-scale machine learning model training across multiple processing units, such as parallel coprocessors, accelerated processors (APUs), central processing units (CPUs), graphical processing units, (GPUs) tensor processors, neural processors, and the like. Large-scale machine learning (ML) techniques have been popularly applied to a wide range of applications, including image and speech recognition, natural language processing, and many others. The training of ML models, especially large-scale models, requires significant computational resources. To handle these computational demands, researchers often utilize multiple GPUs to perform parallel computing, which can significantly reduce the time required for model training.

One technique often used in such contexts is Fully Sharded Data Parallelism (FSDP), a type of data parallelism in which the model's weights, optimizer states, and gradients are sharded, or divided, across a set of multiple GPUs participating in the training. This approach enables the model to exceed the memory constraints of a single GPU and makes it possible to train larger models. However, FSDP necessitates performing various resource-intensive memory operations prior to execution of the matrix-to-matrix multiplication operations (e.g., General Matrix to Matrix Multiplication or GEMM operations) for every layer of the model, posing efficiency challenges for large-scale model training. Therefore, there remains a need for a more efficient way to perform large-scale model training in a fully sharded data parallel setting.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a fully sharded data parallel (FSDP) model training for two data-parallel processes.

FIG. 2 illustrates a high-level overview of General Matrix Multiply (GEMM) operations employed to calculate an output matrix C based on two input matrices.

FIGS. 3-8 illustrate stages of an input-stationary variant of an Integrated Matrix Multiplication (IMM) operation in accordance with some embodiments.

FIGS. 9-12 illustrate stages of an output-stationary variant of an Integrated Matrix Multiplication (IMM) operation in accordance with some embodiments.

FIG. 13 is a block diagram of a processing system suitable for implementing IMM operations in accordance with one or more embodiments.

FIG. 14 is a flow diagram of an operational routine 1400 for performing integrated matrix multiplication operations in accordance with some embodiments.

### DETAILED DESCRIPTION

Fully Sharded Data Parallel (FSDP) is a method for data parallelism in which weights, optimizer states, and gradients are sharded across participating GPUs. As used herein, each such gradient signifies a vector of partial derivatives of a loss function with respect to model parameters. Such gradients represent a sensitivity of the loss function to changes in parameters, and are utilized to adjust weights of the model towards optimal performance.

However, current approaches for implementing FSDP and other data parallelism techniques typically involve the use of bulk-synchronous all-gather and/or all-to-all operations (in which each participating processing unit sends data to all other processing units, and in turn receives data from all other processing units), followed by GEMM operations, for each layer of the ML model. This results in significant communication overhead as the system scales. In particular, the use of bulk-synchronous operations requires temporary buffers to hold the entire weight matrix of an individual layer, leading to further memory overhead. Such operations assemble partitioned parts of the weight matrix from all GPUs, introducing a significant performance overhead. Thus, previous approaches to reduce the overhead of the all-gather operation and the associated buffer memory requirements in large-scale ML model training have failed to optimize a balance between communication (fetching data from other GPUs) and computation (performing GEMM operations).

Embodiments of techniques described herein provide integrated collective-communication and GEMM operations to decrease communication overhead, reduce the associated buffer space utilized during such operations, and increase overlap between communication and computation during the model training process. Such techniques are adaptable to various machine learning models and parallel computing environments. In certain embodiments, collective communication operations (communications transactions with multiple internal buffers and/or processing units) are fused with GEMM computations, referenced herein as integrated matrix multiplication (IMM) operations. Such IMM operations employ GPU-initiated networking to increase the efficiency of matrix computations and enable the support for larger ML models.

An all-gather operation is typically used in parallel computing to gather data from all tasks and distribute it to all tasks, such as in situations in which every process needs access to certain data from one or more other processes. In general, IMM operations involve integrating an all-gather collective communication operation with matrix multiplication computations. In certain embodiments, IMM operations utilize a single GPU kernel that overlaps collective communication and GEMM operations at a finer granularity level. Furthermore, IMM operations reduce the size of a temporary buffer utilized within each GPU, thereby improving overall system performance and enabling the support of larger ML models.

In certain embodiments, IMM operations do not employ a blocking collective operation (e.g., an all-gather operation) but instead utilize non-blocking GET operations, at a tile granularity level, to retrieve data corresponding to one or more input tiles from a remote location. For example, in various scenarios and embodiments the tile data may be retrieved from a memory local to another WG, a memory local to a different node in a distributed computing environment, a memory local to a different processor in a multi-processor system, etc. This IMM approach reduces peak bandwidth requirements and allows for overlapping remote communication with GEMM computation. Due to remote data being accessed at tile granularity, the IMM operations utilize only a small quantity of local buffer storage (in some embodiments storing no more concurrent data in the local buffer than corresponds to two input tiles). In contrast, the FSDP approach typically requires local storage to store the entire associated weight matrix.

In various embodiments, IMM operations utilize an “input stationary” or “output stationary” implementation. For example, in embodiments utilizing an input-stationary IMM operation, retrieved data corresponding to a first input tile is stored in the local buffer while results for multiple output tiles are computed. In contrasting embodiments utilizing output-stationary IMM operations, retrieved data corresponding to a first input tile is used to compute a result for a single output tile while data for multiple tiles of the first input matrix is retrieved into the local buffer. It will be appreciated that in various embodiments, both approaches may be dynamically selected, configured, and utilized in accordance with system architecture, input data parameters, etc.

In certain embodiments, techniques described herein incorporate strategies for efficient data retrieval and reuse in the computation of output tiles, as illustrated in the embodiments. For example, as part of IMM operations a system may selectively reduce the number of non-blocking remote GET calls issued for the retrieval of data from an input matrix, such as by reusing data that has already been retrieved into local buffer storage for the computation of multiple output tiles.

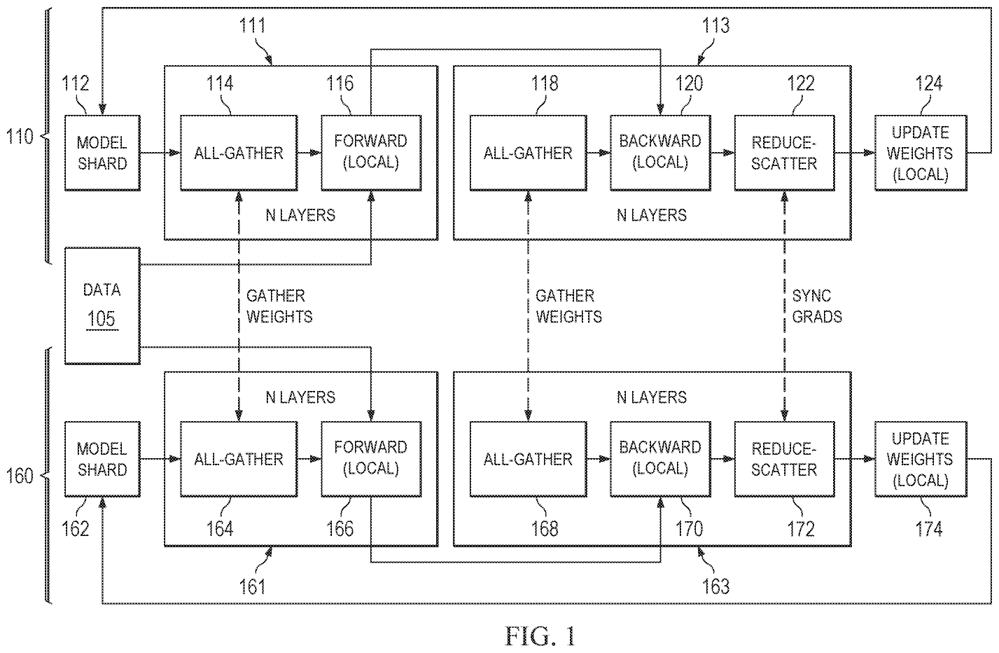

FIG. 1 illustrates a fully sharded data parallel (FSDP) model training for two data-parallel processes 110 and 160. It will be appreciated that although for ease of illustration only two such parallel processes are depicted, a much larger quantity of parallel processes are typically performed in the illustrated manner. The parallel processes 110 and 160 depict a typical FSDP model training cycle, where each of the processes 110, 160 communicates intensively through a series of all-gather operations for both forward and backward pass computations.

Process 110 commences with a model shard 112, which represents a portion or shard of the total model parameters allocated to the process 110. The N forward pass layers 111, which are fed from model shard 112, comprise two main operations: an all-gather operation 114, which collects all relevant parameters from different model shards across all of the parallel processes for the forward pass of the computation of a specific layer. This is a highly resource-intensive operation due to the requisite data transfer across all of the multiple executing parallel processes. Secondly, a compute forward pass operation 116 utilizes the parameters gathered in all-gather operation 114 to execute the forward pass computation for the respective layer. The compute forward pass operation 116 utilizes common input data 105.

Following the N forward pass layers 111, the N backward pass layers 113 comprise similar operations. A subsequent all-gather operation 118 amasses the parameters required for the backward pass computation of the respective layer. Following this all-gather operation 118, a compute backward pass operation 120 utilizes both the gathered parameters from the all-gather operation 118 and results from the compute forward pass operation 116 to execute the backward pass computation. This stage is succeeded by a reduce-scatter operation 122, which aggregates the gradients and scatters the aggregated gradients back to the respective processes that are responsible for the corresponding parameters. The parallel process 110 concludes with an update weights operation 124, in which the parameters assigned to that process are updated with the aggregated gradients. The updated weights are then fed back into the model shard 112, ready for the next forward pass computation.

Process 160 is substantially identical to the process 110, starting from its respective model shard 162. The N forward pass layers 161 are fed from model shard 162 and include an all-gather operation 164 and a compute forward pass operation 166, in a manner substantially similar to that described above with respect to process 110. The backward pass layers 163, like the forward pass layers 161, perform an all-gather operation 168, followed by a compute backward pass operation 170. The compute backward pass operation 170 utilizes parameters from the all-gather operation 168 and results from the compute forward pass operation 166. This is followed by a reduce-scatter operation 172 and an update weights operation 174, which concludes the cycle for process 160. The updated weights are then fed back into the model shard 162.

This cyclic and repetitive process for each of the N layers in processes 110 and 160 shows the resource-intensive nature of the all-gather operations 114 and 118 in process 110, and all-gather operations 164 and 168 in process 160. Such all-gather operations being performed twice for each of the N layers (once in the forward pass and once in the backward pass) result in substantial communication and computational costs associated with the FSDP model training process.

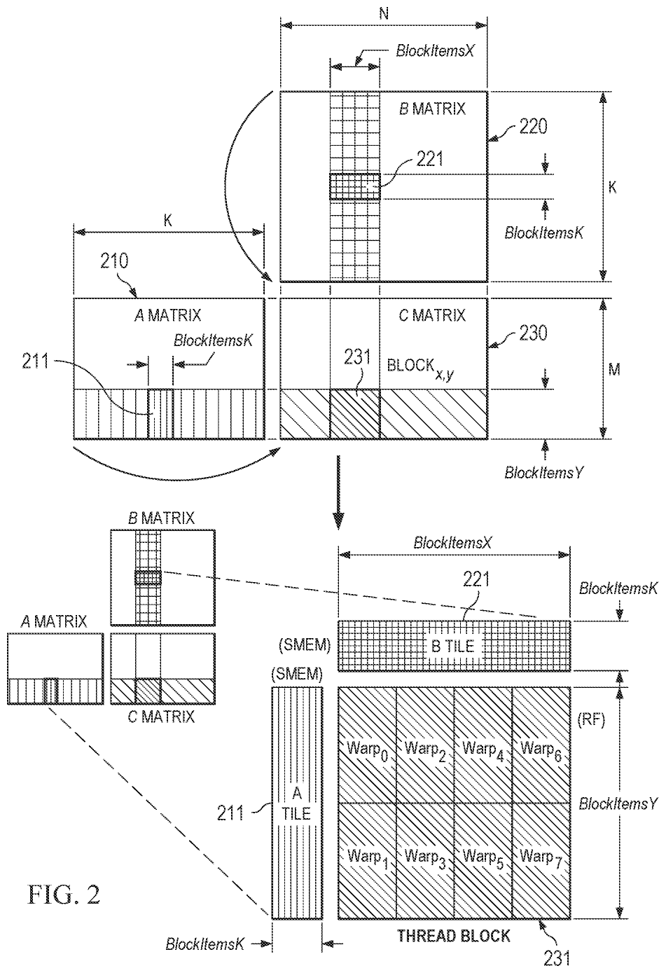

FIG. 2 illustrates a high-level overview of General Matrix Multiply (GEMM) operations employed to calculate an output matrix C (230) based on two input matrices, input matrix A (210) and input matrix B (220). Matrix A (210) presents dimensions of K (horizontal) by M units (vertical); matrix B (220) displays dimensions of N (horizontal) and K (vertical).

Computation of a representative output tile 231 from the C matrix (230) is performed by utilizing an exemplary input tile 211 from matrix A (210) and exemplary input tile 221 from matrix B (220). As shown, the input tile 211 of matrix A (210) comprises dimensions of BlockItemsK wide and BlockItemsY high. Similarly, the input tile 221 of matrix B (220) comprises dimensions of BlockItemsX wide and BlockItemsK high. Output tile 231, produced as a result of these computations, is shown as having dimensions of BlockItemsX wide and BlockItemsY high.

During computation, output tile 231 is separated among a 4×2 thread block, with each of these blocks comprising concurrently executing threads termed Warp0 through Warp7, respectively. The computation of output tile 231 is performed by iteratively loading tiles (e.g., input tiles 211 and 221) from input matrices 210 and 220. For each iteration, the requirement only extends to individual input tiles from the input matrices, negating the need for the entire submatrix. At each iteration, only individual tiles from input matrices 210, 220 are utilized, while each output tile of the output matrix 230 is stored within registers until fully computed—that is, product tiles of output matrix 230 (such as exemplary product tile 231) are loaded only once, while input tiles of input matrices 210, 220 (such as exemplary input tiles 211, 221) are loaded from memory repeatedly. This approach is generally termed output-stationary or C-stationary, and is commonly used for GEMM operations in single-GPU configurations. Alternatively, one of the input matrix tiles (e.g., input tile 211 or input tile 221) can be maintained within registers while tiles of the other matrices are loaded from memory repeatedly. This variant is generally referred to as input-stationary.

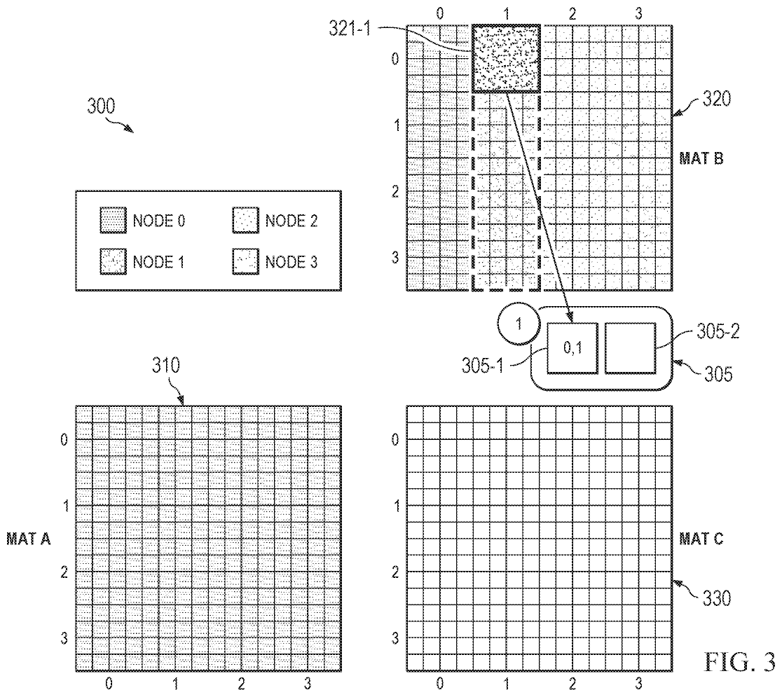

FIGS. 3-8 illustrate an input-stationary variant of an Integrated Matrix Multiplication (IMM) operation in accordance with some embodiments.

FIG. 3 depicts a first stage 300 of the input-stationary IMM operation, in which a primary input matrix A (input matrix 310), and a secondary input matrix B (input matrix 320) are to be multiplied to yield an as-yet-uncalculated output matrix C (output matrix 330). Each of matrices 310, 320, 330 is represented as a tiled 4×4 grid, and is shown for ease of illustration using a coordinate system of 0-3 in each of the Y and X dimensions. For example, the upper-left tile of the grid occupies the coordinates 0,0, and the lower-right tile situates itself at the coordinates 3,3.

In the depicted embodiment, a temporary buffer 305 is configured to selectively and temporarily store up to two tiles of data from any of the matrices 310, 320, 330 during execution of the IMM operation.

In stage 300, a workgroup (WG, not shown) assigned to compute the tile (0,1) in output matrix 330 initiates a remote GET call to load data from an input tile 321-1 into a first buffer slot 305-1 of the temporary buffer 305. This remote data access is structured to be concealed behind other calculations involving output matrix 330. More specifically, these hidden calculations are related to the computations of the output matrix 330 tile at coordinates (0:3,0) that other WGs handle and rely on local data of both input matrices 310, 320. This arrangement advantageously enables multiple operations to occur simultaneously, increasing computational efficiency.

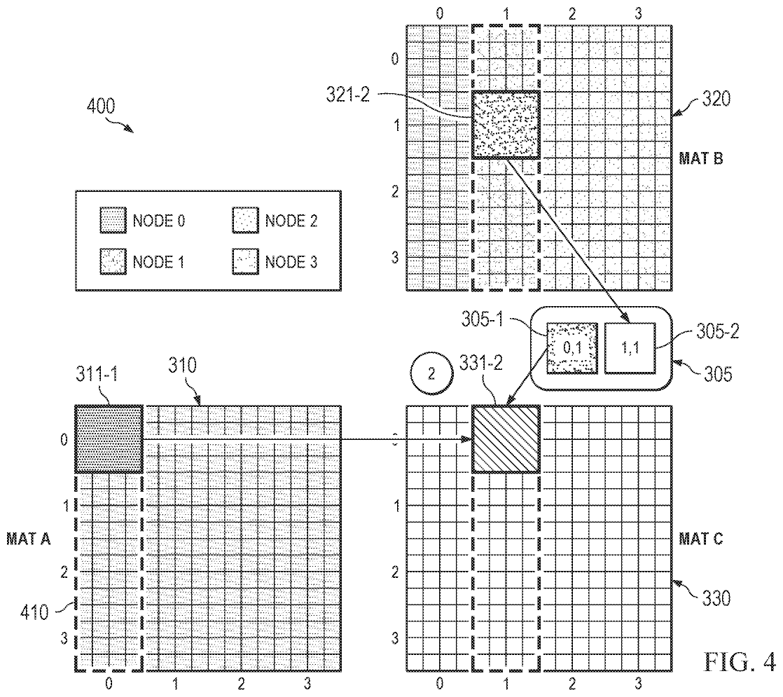

FIG. 4 depicts a second stage 400 of the input-stationary IMM operation in accordance with some embodiments. Stage 400 builds upon the preparatory data fetching operation initiated in stage 300, using data stored in temporary buffer 305 and further computations for the output matrix 330.

As shown, the first buffer slot 305-1 in temporary buffer 305 holds the fetched tile 321-1 from input matrix 320, loaded in stage 300 via the remote GET call. This tile data is labeled “0,1” in the first buffer slot 305-1, marking its coordinate origins in the input matrix 320.

In stage 400, the WG calculates a first output tile 331-1 of output matrix 330 at coordinates (0,1). A partial product corresponding to the output tile 331-1 is computed using the data from input tile 321-1, now stored in the first buffer slot 305-1 of temporary buffer 305, and a corresponding tile 311-1 from input matrix 310.

Substantially simultaneously, as the computation for tile 331-1 in output matrix 330 progresses, the WG issues a non-blocking remote GET call for a second tile 321-2, situated at coordinates (1,1) in input matrix 320. This operation serves to load tile 321-2 into the second buffer slot 305-2 of temporary buffer 305, while the non-blocking GET call allows for concurrent execution of the GET call and that computation using data from tile 321-1. This parallel execution further contributes to the operational efficiency of the IMM operation, reducing the idle time of the processing units. Thus, stage 400 illustrates the handling of data stored in temporary buffer 305 for computation and the initiation of parallel GET calls to load subsequent data needed for future stages of the IMM operation.

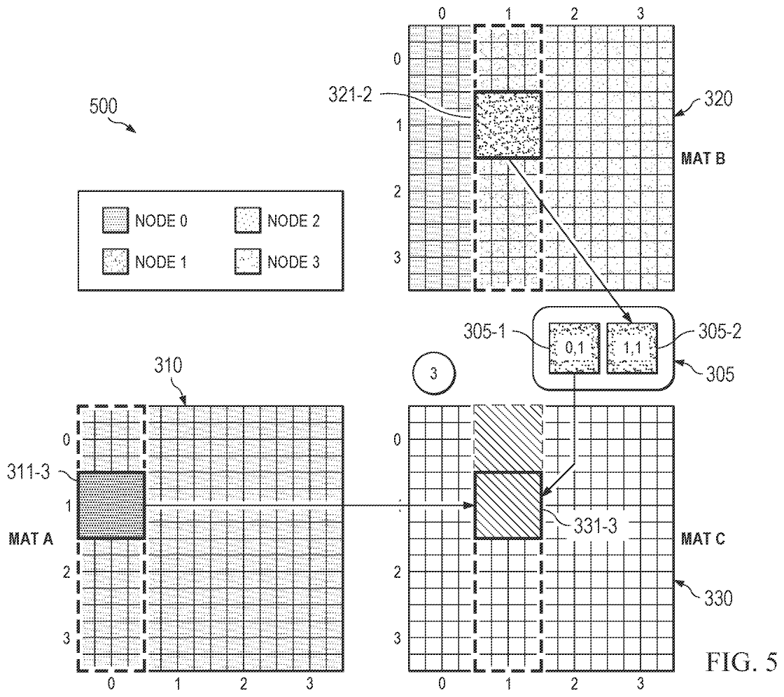

FIG. 5 illustrates a third stage 500 of the input-stationary IMM operation in accordance with some embodiments. As shown, both buffer slots of temporary buffer 305 contain data from input matrix 320: the first buffer slot 305-1 continues to store tile 321-1 from coordinates (0,1), and the second buffer slot 305-2 now stores the recently fetched data of tile 321-2 from coordinates (1,1), as described in the previous stage 400.

Stage 500 depicts iterative operation over input matrix 310 and output matrix 330 to generate partial products using the stored tile 321-1. In particular, data from the first buffer slot 305-1 and a corresponding input tile 311-3 in input matrix 310 are used to compute a new output tile 331-3 in output matrix 330, continuing the usage of the stored data of tile 321-1 from input matrix 320, coupled with data from correspondingly iterating tiles from the input matrix 310, to compute corresponding tiles of the output matrix 330. In this manner, the use of tile 321-1 from the first buffer slot 305-1 aids in the computation of a series of partial product output tiles in output matrix 330 while effectively hiding the remote data access time for tile 321-2.

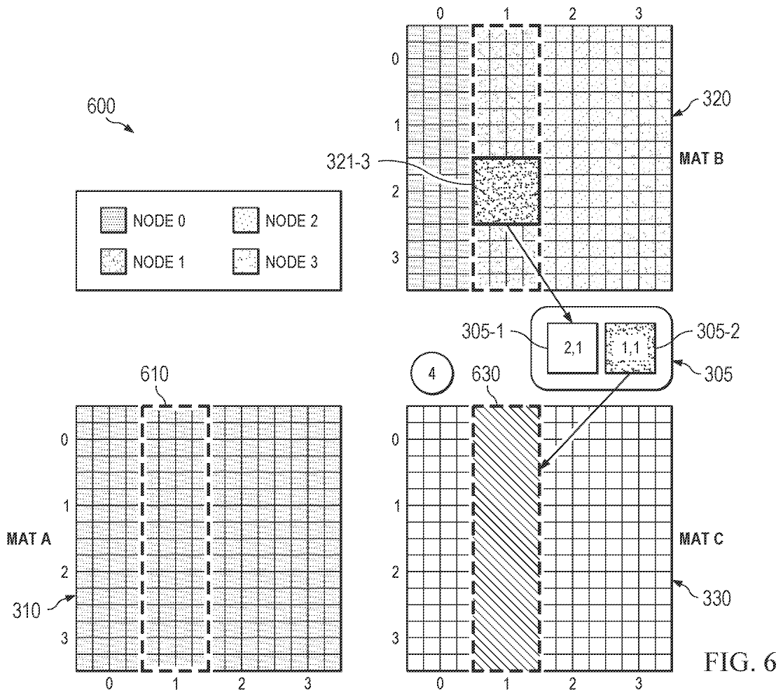

FIG. 6 depicts a fourth stage 600 of the input-stationary IMM operation in accordance with some embodiments.

As shown, data from tile 321-3 of the input matrix 320 is loaded into the first buffer slot 305-1 (labeled “2,1” to indicate its coordinate origins in the input matrix 320) for use in subsequent computations. Substantially simultaneously, computation is iteratively performed for the output tiles of column 630 in the output matrix 330, using the data from tile 321-2 (still stored in the second buffer slot 305-2) and from the corresponding tiles of column 610 in input matrix 310.

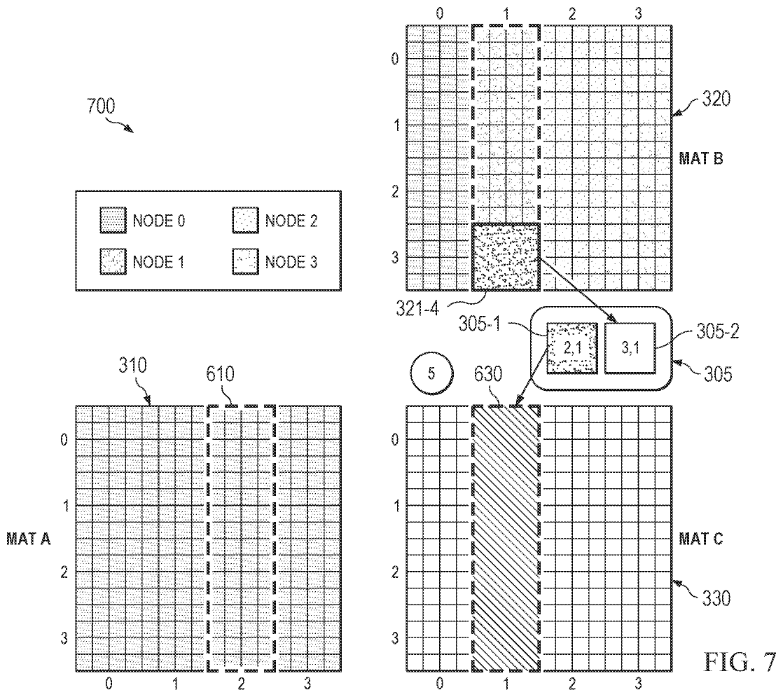

FIG. 7 depicts a fifth stage 700 of the input-stationary IMM operation in accordance with some embodiments. Stage 700 illustrates a continuation of the iterative data usage and computational cycles exemplified in the previous stages.

The first buffer slot 305-1 of temporary buffer 305 retains the data of tile 321-3 from the input matrix 320 (labeled “2,1” to indicate the coordinate origins of the stored data) for continued utilization in generating output tiles of column 630 in the output matrix 330. As that computation is performed, another non-blocking remote GET call is issued to load data from a subsequent tile 321-4 located at coordinates (3,1) of input matrix 320 into the second buffer slot 305-2. Here, the overlapping of the non-blocking GET call and the ongoing computations continues to effectively reduce the idle time of the processing units, enhancing the efficiency of the IMM operation.

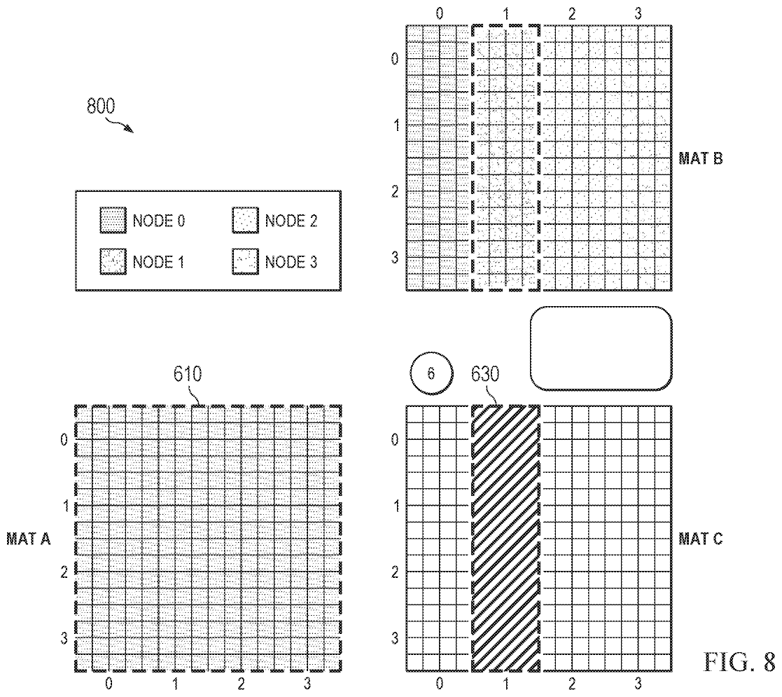

As shown in FIG. 8, upon completion of computations involving the tile from input matrix 320 at coordinates (3,1), the final submatrix (0:3,1) (corresponding to column 630) of output matrix 330 is fully computed. It will be appreciated that although for ease of illustration, the IMM operations of FIGS. 3-8 explicitly only depict the calculation of the column 630 within the output matrix 330, the calculation of the rest of output matrix 330 is similarly performed. Moreover, in scenarios and embodiments in which additional workgroups are available for use in performing the IMM operations, such additional calculation may be performed subsequently or concurrently with the calculations described above with respect to the portions of output matrix 330 shown via the calculation of column 630.

In various embodiments, a variety of workgroup configurations may be employed as part of the IMM operation. For instance, in certain scenarios an individual workgroup may be tasked with the computation of partial products using a single tile from input matrix 320. This approach might necessitate the use of atomic operations to facilitate proper coordination and concurrent execution. Alternatively, in various embodiments and scenarios a workgroup might be allocated the task of computing multiple tiles of output matrix 330.

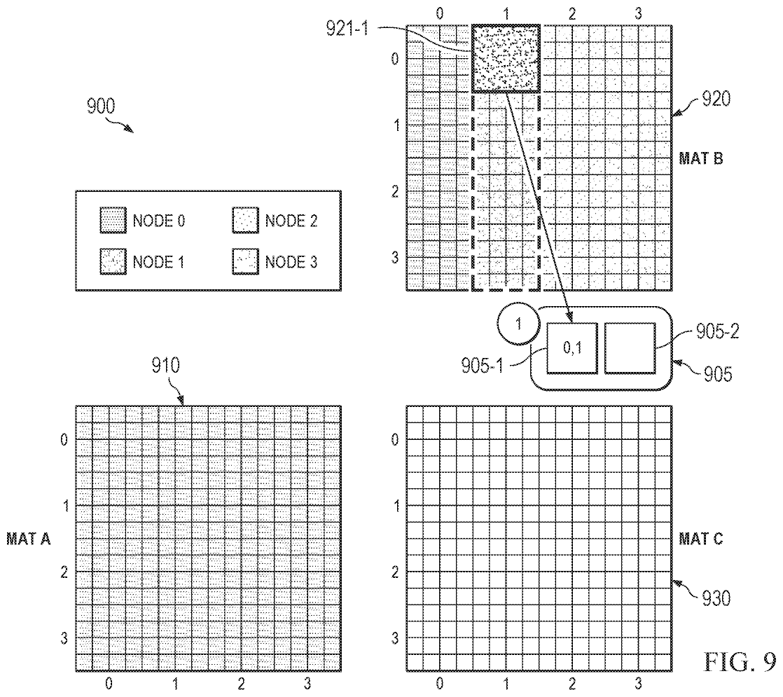

FIGS. 9-12 illustrate four stages of an output-stationary variant of an Integrated Matrix Multiplication (IMM) operation in accordance with some embodiments.

FIG. 9 depicts a first stage 900 of the output-stationary IMM operation, substantially identical to the first stage 300 of the input-stationary IMM operation depicted in FIG. 3. A primary input matrix A (input matrix 910) and a secondary input matrix B (input matrix 920) are to be multiplied to yield an as-yet-uncalculated output matrix C (output matrix 930). In a manner similar to that described above with respect to matrices 310, 320, 330 of FIG. 3, each of matrices 910, 920, 930 is represented as a tiled 4×4 grid using a coordinate system of 0-3 in each of the Y and X dimensions. A temporary buffer 905 is configured to selectively and temporarily store up to two tiles of data from any of the matrices 910, 920, 930 during execution of the IMM operation.

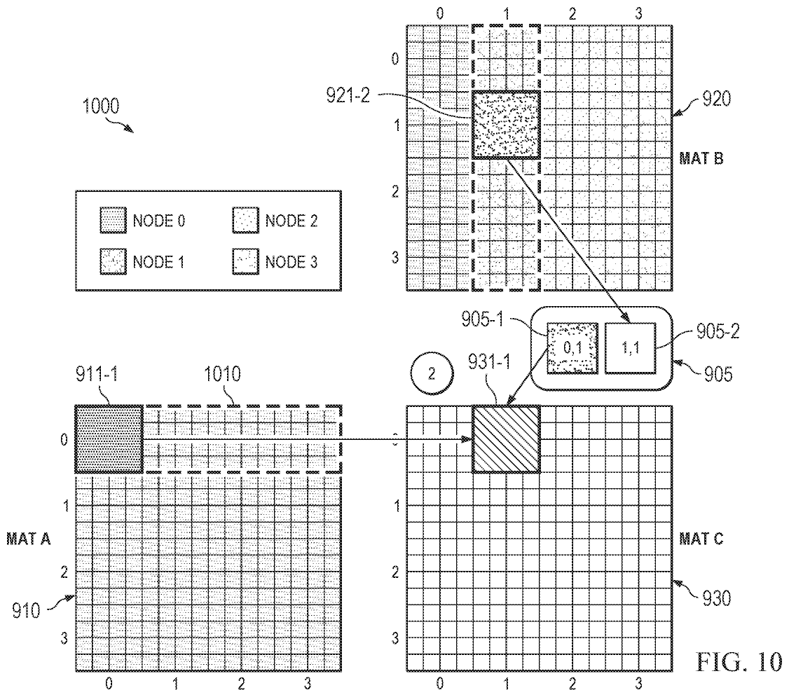

In stage 900, a WG (not shown) that is assigned to compute an output tile in output matrix 930 initiates a remote GET call to load data from an input tile 921-1 into a first buffer slot 905-1 of the temporary buffer 905. As seen below with respect to FIG. 10, this remote data access is structured to be concealed behind other calculations for output tiles of the matrix 930 at coordinates (0:3,0).

FIG. 10 illustrates a second stage 1000 of the output-stationary IMM operation in accordance with some embodiments. Notably, although the stage 1000 is similar to stage 400 of the input-stationary embodiment from FIG. 4, in stage 1000 the workgroup calculates the output tile 931-1 using tile data from input matrix 920 (as stored in the temporary buffer 905) and iterative operations over each row of input matrix 910 (e.g., row 1010), in contrast with performing iterative operations over each column of the input matrix (e.g., as described elsewhere herein with respect to the processing of input column 410 in FIG. 4 and input column 610 in FIG. 6). Concurrently, as computations progress, non-blocking remote GET calls are issued to fetch data from successive tiles from input matrix 920 required in subsequent iterations (such as tile 921-2 located at coordinates (1,1)) into the temporary buffer 905. Thus, as with the input-stationary embodiment of FIGS. 3-8, the output-stationary IMM operation enables simultaneous execution of the GET calls and submatrix computation.

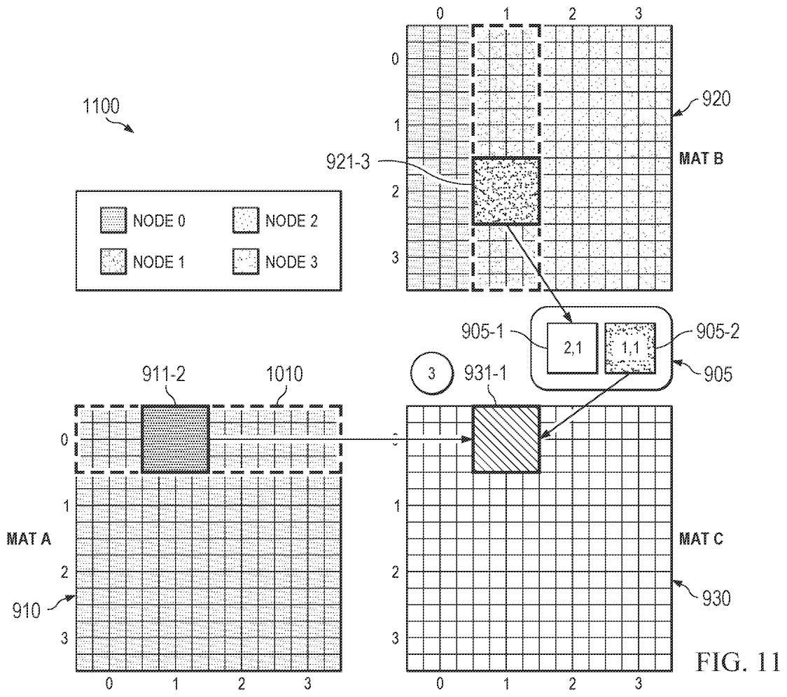

FIG. 11 illustrates a third stage 1100 of the output-stationary IMM operation in accordance with some embodiments. During this stage, another non-blocking remote GET call is initiated to load data from an input tile 921-3 (at coordinates (2,1) of the input matrix 920) into buffer slot 905-1 while computation for output tile 931-1 continues. The computation now involves the multiplication of data from an input tile 911-2 of input matrix 910 and data from input tile 921-2 stored in the buffer slot 905-2.

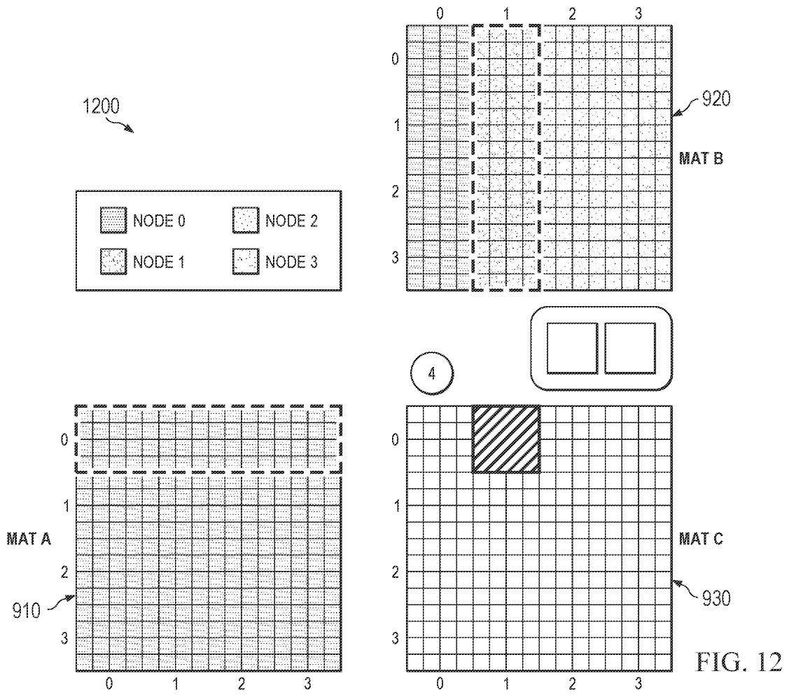

FIG. 12 depicts a fourth and final stage 1200 of the output-stationary IMM operation in accordance with some embodiments. At this stage, after all relevant tiles of input matrices 910 and 920 have been iterated over, the final output tile 931-1 in output matrix 930 is fully computed.

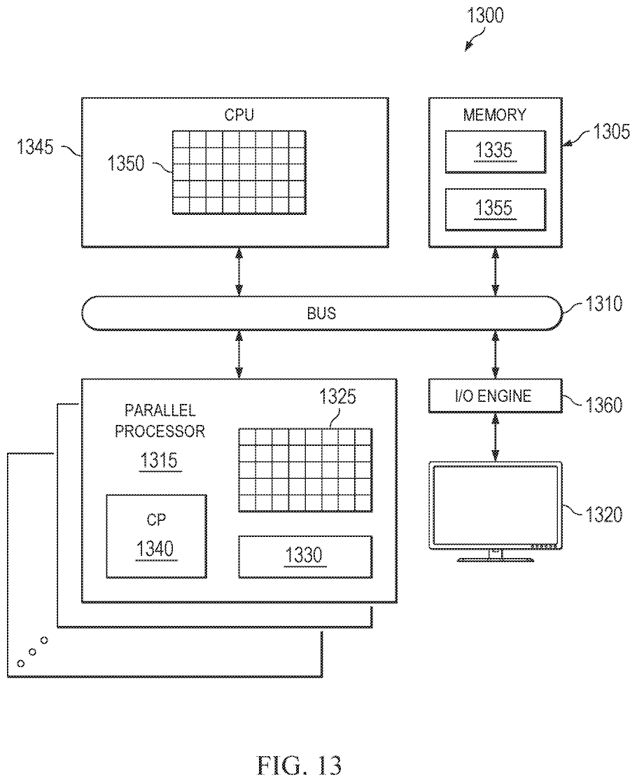

FIG. 13 is a block diagram of a processing system 1300 designed to implement IMM operations (e.g., an input-stationary IMM operation such as that described elsewhere herein with respect to FIGS. 3-8 and/or an output-stationary IMM operation such as that described with respect to FIGS. 9-12) in accordance with one or more embodiments. The processing system 1300 is generally designed to execute sets of instructions or commands to carry out tasks on behalf of an electronic device, such as a desktop computer, laptop computer, server, smartphone, tablet, game console, and the like.

The processing system 1300 includes or has access to a memory 1305 or other storage component that is implemented using a non-transitory computer readable medium, such as dynamic random access memory (DRAM). The processing system 1300 also includes a bus 1310 to support communication between entities implemented in the processing system 1300, such as the memory 1305. In certain embodiments, the processing system 1300 includes other buses, bridges, switches, routers, and the like, which are not shown in FIG. 13 in the interest of clarity.

The processing system 1300 includes one or more parallel processors 1315 that are configured to generate content for presentation on a display 1320. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 1315 can render objects to produce pixel values that are provided to the display 1320. In some implementations, parallel processors are separate devices that are included as part of a computer. In other implementations such as advance processor units, parallel processors are included in a single device along with a host processor such as a central processor unit (CPU). Thus, although embodiments described herein may utilize a graphics processing unit (GPU) for illustration purposes, various embodiments and implementations are applicable to other types of parallel processors.

In certain embodiments, the parallel processor 1315 is also used for general-purpose computing. For instance, the parallel processor 1315 can be used to implement matrix multiplication operations, such as one or more implementations of IMM operations as described herein. In various scenarios and embodiments, operations of multiple parallel processors 1315 are coordinated to execute various processing tasks.

The parallel processor 1315 implements multiple processing elements (also referred to as compute units) 1325 that are configured to execute instructions concurrently or in parallel. The parallel processor 1315 also includes an internal (or on-chip) memory 1330 that includes a local data store (LDS), as well as caches, registers, or buffers utilized by the compute units 1325. The parallel processor 1315 can execute instructions stored in the memory 1305 and store information in the memory 1305 such as the results of the executed instructions. The parallel processor 1315 also includes a command processor 1340 that receives task requests and dispatches tasks to one or more of the compute units 1325.

The processing system 1300 also includes a central processing unit (CPU) 1345 that is connected to the bus 1310 and communicates with the parallel processor 1315 and the memory 1305 via the bus 1310. The CPU 1345 implements multiple processing elements (also referred to as processor cores) 1350 that are configured to execute instructions concurrently or in parallel. The CPU 1345 can execute instructions such as program code 1355 stored in the memory 1305 and the CPU 1345 can store information in the memory 1305 such as the results of the executed instructions.

An input/output (I/O) engine 1360 handles input or output operations associated with the display 1320, as well as other elements of the processing system 1300 such as keyboards, mice, printers, external disks, and the like. The I/O engine 1360 is coupled to the bus 1310 so that the I/O engine 1360 communicates with the memory 1305, the parallel processor 1315, or the CPU 1345.

In operation, the CPU 1345 issues commands to the parallel processor 1315 to initiate processing of a kernel that represents the program instructions that are executed by the parallel processor 1315. Multiple instances of the kernel, referred to herein as threads or work items, are executed concurrently or in parallel using subsets of the compute units 1325. In some embodiments, the threads execute according to single-instruction-multiple-data (SIMD) protocols so that each thread executes the same instruction on different data. The threads are collected into workgroups (also termed thread groups) that are executed on different compute units 1325. For example, the command processor 1340 can receive these commands and schedule tasks for execution on the compute units 1325.

In some embodiments, the parallel processor 1315 implements a graphics pipeline that includes multiple stages configured for concurrent processing of different primitives in response to a draw call. Stages of the graphics pipeline in the parallel processor 1315 can concurrently process different primitives generated by an application, such as a video game. When geometry is submitted to the graphics pipeline, hardware state settings are chosen to define a state of the graphics pipeline. Examples of state include rasterizer state, a blend state, a depth stencil state, a primitive topology type of the submitted geometry, and the shaders (e.g., vertex shader, domain shader, geometry shader, hull shader, pixel shader, and the like) that are used to render a scene.

In various embodiments, each computational and/or communications task performed as part of IMM operations is processed in parallel by the compute units 1325 in the parallel processor 1315. As discussed elsewhere herein, this approach enables efficient IMM operations without excessive all-gather operations in a wide range of devices and applications.

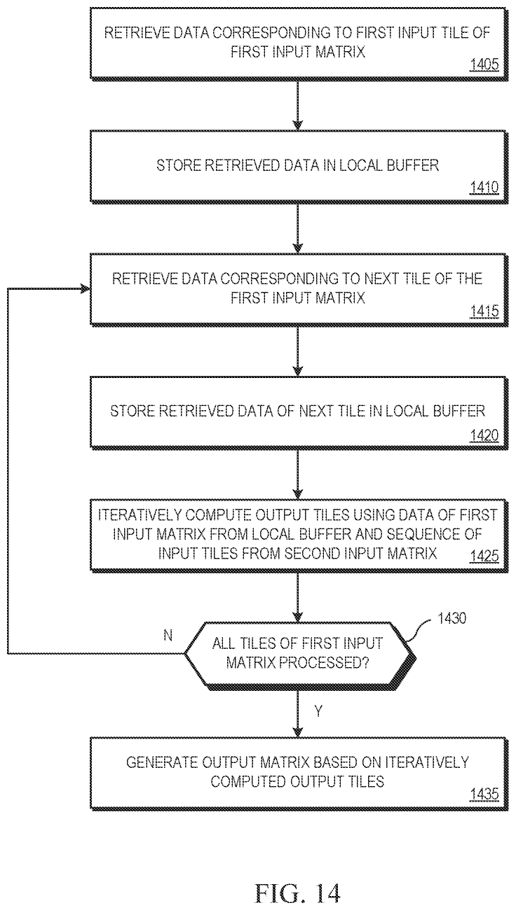

FIG. 14 is a flow diagram of an operational routine 1400 for performing integrated matrix multiplication operations in accordance with some embodiments. The routine 1400 may be performed, for example, by processing system 1300 from FIG. 13, or other processing system configured in accordance with techniques described herein.

The routine 1400 begins at block 1405, in which data corresponding to a first input tile of a first input matrix is retrieved; at block 1410, that retrieved data is stored in a local buffer. The routine proceeds to block 1415.

At block 1415, data corresponding to the next tile of the first input matrix is retrieved. The routine proceeds to block 1420, in which the retrieved data of that next tile from the first input matrix is stored in a local buffer. In certain embodiments, the retrieved data from the next tile is stored in the same local buffer as that utilized in block 1410; in other embodiments, the retrieved data is stored in a different local buffer. In either case, the routine proceeds to block 1425.

At block 1425, output tiles are iteratively computed using data of the first input matrix retrieved from local buffer storage and using a sequence of input tiles from a second input matrix (that being matrix-multiplied with the first input matrix). As discussed elsewhere herein, in certain implementations the sequence of input tiles is a unidimensional sequence, such as from a single row or column of input tiles from the second input matrix. The routine proceeds to block 1430.

At block 1430, the processing system determines whether all input tiles of the first input matrix have been processed. If not, the routine returns to block 1415 to retrieve additional data for additional iterative computations. If so, the routine proceeds to block 1435.

At block 1435, the processing system generates an output matrix comprising the computed results of multiplying the first input matrix and the second input matrix, based on the iteratively computed output tiles generated in block 1425.

In some embodiments, the apparatus and techniques described above are implemented in a system including one or more integrated circuit (IC) devices (also referred to as integrated circuit packages or microchips), such as the IMM operations and systems described above with reference to FIGS. 3-13. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method to compute an output matrix based on two input matrices, the method comprising:
retrieving data corresponding to a first input tile of a first input matrix;
storing the retrieved data in a local buffer; and
for each output tile of a plurality of output tiles in the output matrix, computing a result for the output tile by:
retrieving data corresponding to a next tile of the first input matrix into the local buffer for use in subsequent computations of the output tile; and
concurrently with processing of the retrieving, iteratively computing the output tile using the data of the first input matrix stored in the local buffer and a unidimensional sequence of input tiles from a second input matrix; and
generating the output matrix based on the iteratively computed plurality of output tiles.

2. The method of claim 1, wherein the method is performed by a processor workgroup (WG) assigned to compute one or more output tiles of the plurality of output tiles.

3. The method of claim 2, wherein retrieving the data corresponding to the first input tile comprises retrieving the data via a non-blocking remote call from a remote location external to the WG.

4. The method of claim 3, wherein the remote location is one of a memory local to another WG, a memory local to a different node in a distributed computing environment, or a memory local to a different processor in a multi-processor system.

5. The method of claim 2, wherein the method is concurrently performed by a plurality of WGs that are each assigned to compute results for a distinct subset of the plurality of output tiles.

6. The method of claim 1, wherein the method comprises storing no more concurrent data in the local buffer than corresponds to two input tiles.

7. The method of claim 1, wherein the method comprises an input-stationary integrated matrix multiplication operation, such that the retrieved data corresponding to the first input tile is stored in the local buffer while results for multiple output tiles are computed.

8. The method of claim 1, wherein the method comprises an output-stationary integrated matrix multiplication operation, such that the retrieved data corresponding to the first input tile is used to compute a result for a single output tile while data for multiple tiles of the first input matrix is retrieved into the local buffer.

9. The method of claim 1, wherein the unidimensional sequence of input tiles from the second input matrix is a sequence of input tiles along a row of the second input matrix or along a column of the second input matrix.

10. The method of claim 1, further comprising selectively reducing a number of non-blocking remote calls issued for retrieval of data from the first input matrix by reusing data retrieved into the local buffer for computation of multiple output tiles.

11. A system for computing an output matrix based on two input matrices, the system comprising:
a local buffer configured to store data corresponding to a first input tile of a first input matrix; and
a processor configured to:
retrieve data corresponding to the first input tile,
store the retrieved data in the local buffer, and
for each output tile of a plurality of output tiles in the output matrix, compute a result for the output tile by:
retrieving data corresponding to a next tile of the first input matrix into the local buffer for use in subsequent computations of the output tile; and
concurrently with processing of the retrieving, iteratively computing the output tile based on the data of the first input matrix stored in the local buffer and a unidimensional sequence of input tiles from a second input matrix; and
generate the output matrix based on the iteratively computed plurality of output tiles.

12. The system of claim 11, wherein the processor comprises multiple workgroups (WGs) that are each assigned to compute a result for one or more output tiles of the plurality of output tiles.

13. The system of claim 11, wherein the processor is configured to retrieve the data corresponding to the first input tile via a non-blocking remote call from a remote location external to the processor.

14. The system of claim 13, wherein the remote location is one of a memory local to a different node in a distributed computing environment or a memory local to a different processor in a multi-processor system.

15. The system of claim 11, wherein the local buffer is configured to store no more concurrent data than corresponds to two input tiles.

16. The system of claim 11, wherein the processor is configured to perform an input-stationary integrated matrix multiplication operation, such that the retrieved data corresponding to the first input tile is stored in the local buffer while results for multiple output tiles are computed.

17. The system of claim 11, wherein the processor is configured to perform an output-stationary integrated matrix multiplication operation, such that the retrieved data corresponding to the first input tile is used to compute a result for a single output tile while data for multiple tiles of the first input matrix is retrieved into the local buffer.

18. The system of claim 11, wherein the unidimensional sequence of input tiles from the second input matrix is a sequence of input tiles along a row of the second input matrix or along a column of the second input matrix.

19. The system of claim 11, wherein the processor is further configured to selectively reduce a number of non-blocking remote calls issued for retrieval of data from the first input matrix by reusing data retrieved into the local buffer for computation of multiple output tiles.

20. A non-transitory computer-readable medium storing instructions that, when executed by one or more processors, cause the one or more processors to:
retrieve data corresponding to a first input tile of a first input matrix;
store the retrieved data in a local buffer; and
for each output tile of a plurality of output tiles in an output matrix, compute a result for the output tile by:
retrieving data corresponding to a next tile of the first input matrix into the local buffer for use in subsequent computations of the output tile; and
concurrently with processing of the retrieving, iteratively computing the output tile using the data of the first input matrix stored in the local buffer and a unidimensional sequence of input tiles from a second input matrix; and
generate the output matrix based on the iteratively computed plurality of output tiles.
